(19) United States
(12) Patent Application Publication
(10) Pub. No.: US 2013/0107314 A1
(43) Pub. Date: May 2, 2013

(54) METHODS AND APPARATUS FOR CLOUD PRINTING

(71) Applicants: FORREST LANE STEELY, LEXINGTON, KY (US); JAMES ROBERT PRINCE, LEXINGTON, KY (US)

(72) Inventors: FORREST LANE STEELY, LEXINGTON, KY (US); JAMES ROBERT PRINCE, LEXINGTON, KY (US)

(21) Appl. No.: 13/286,606

(22) Filed: Nov. 1, 2011

(51) Int. Cl. G06F 15/00

(52) U.S. Cl. 358/1.15

(57) ABSTRACT

A method of printing at an imaging device includes initiating a search for a server registered to a domain using zero configuration networking, receiving a print job associated with a user account from the server and printing the print job.

### CROSS REFERENCE TO RELATED APPLICATIONS

None.

### STATEMENT REGARDING FEDERALLY SPONSORED RESEARCH OR

DEVELOPMENT

None.

### REFERENCE TO SEQUENTIAL LISTING, ETC.

None.

### BACKGROUND

1. Technical Field

The present disclosure relates to printing, and, more particularly, to cloud printing.

2. Description of the Related Art

There are a number of commercially available cloud printing solutions that enable users to access print jobs remotely from the Internet cloud. In the current available solutions, only selected printers that are known to the print server are able to retrieve and print the jobs. To print a job, either the printers have to be configured to be able to locate a print server on the Internet, or the server has to be preconfigured to be aware of the printers.

Existing methods of retrieving print jobs from the cloud require users to register at least one printer with their account, and only those registered printers can be used to release the user's print jobs. Another existing method requires that each printer have a unique e-mail address and be specified to the server in advanced in order to be used to print the print job. A disadvantage of using these methods occurs if there are changes in the network. When a change in the network, such as a change in IP addresses, occurs, a print server may not be able to find the printers that were previously registered to the server. Re-configuration of some nodes in the network may make finding a printer capable of printing the job difficult.

Accordingly, there is a need for a solution that eliminates the requirement for printers to be manually configured or registered before becoming available to process print jobs retrieved from the cloud and to eliminate the restrictions of having one or at most, only a small handful of printers, available to retrieve the print jobs. There is also a need for a solution that allows printers in varying locations to be used to release the print job without manual network configuration from a user. There is a further need for printers and other end-point devices, such as scanners, back up disks and network video cameras, to find a server in a wide area network to retrieve and/or send files, such as print jobs, from the server.

### SUMMARY

According to one example embodiment of the present disclosure, there is provided a method of printing at an imaging device. The imaging device may initiate a search for a server using zero configuration networking, establish a communications protocol with the server, receive a print job associated with a user account from the server, and print the print job.

In one aspect, the zero configuration networking may be implemented in a wide area network. In another aspect of the first example embodiment, the imaging device may determine a geographic location of the imaging device and search for a server nearest to the geographic location of the imaging device.

In yet another aspect of the first example embodiment, the imaging device may receive user authentication details associated with the user account from a user. The imaging device may transmit the user authentication details received from a user to the server. In another aspect, the imaging device may receive the domain to be searched from a user. In still another aspect of the first example embodiment, the imaging device may receive the domain to be searched from a user, wherein the domain may be pre-set in the imaging device. In one aspect of the first example embodiment, the server may be a cloud print server. In another aspect, the imaging device may be a cloud printing release station.

Other embodiments, objects, features and advantages of the disclosure will become apparent to those skilled in the art from the detailed description, the accompanying drawings and the appended claims.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 is a schematic diagram of a data communication system according to one example embodiment.

FIG. 2 is a flowchart of one example method of locating a print server for use in a to cloud printing solution.

FIG. 3 is a flowchart of one example method of communicating with a print server to release print jobs to an imaging device for printing for use in conjunction with the example method of FIG. 2.

FIG. 4 is a flowchart of a second example method of communicating with a print server to release print jobs to imaging device for printing for use in conjunction with the example method of FIG. 2.

### DETAILED DESCRIPTION OF THE DRAWINGS

The following description and drawings illustrate embodiments sufficiently to enable those skilled in the art to practice the present disclosure. It is to be understood that the disclosure is not limited to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, the terms “a” and “an” herein do not denote a limitation of quantity, but rather denote the presence of at least one of the to referenced item.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block of the diagrams or combinations of blocks in the diagrams discussed in detail in the descriptions below.

These computer program instructions may also be stored in a non-transitory computer-readable memory that may direct a computer or other programmable data processing apparatus to function in a particular manner, such that the instructions stored in the computer-readable memory produce an article of manufacture including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, the blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps or combinations of special purpose hardware and computer instructions.

Disclosed are systems and methods for retrieving print jobs from a print server in the cloud. According to one example embodiment of the present disclosure, a user of a client device may send one or more files for printing to a print server via a network using a cloud printing solution. The one or more files may be stored by the print server in a storage location remote from the client device and/or the print server for subsequent retrieval of the one or more files for printing by an imaging device. Such storage location may either be a storage server or the same server on which the print server is running When the user is ready to print the one or more files, the user may approach the imaging device and activate a cloud printing application in the imaging device to search the print server via zero configuration and retrieve the one or more files from the print server for printing.

For purposes of the present disclosure, it will be appreciated that the one or more files may consist of text, documents, photos or any other file that may be used to generate or produce a printed output on a media. The process for printing the one or more files may require that the one or more of these files be processed or reassembled into a format that resembles that which is displayed on an interface when the one or more files are accessed. If the one or more files displayed on or retrieved by the imaging device are not in a format that the imaging device recognizes or is capable of printing, a transform or conversion process may be performed on the one or more files in order to convert the one or more files into a format recognizable by the imaging device, i.e., a printable format. Printable formats may include, but are not limited to, PCL, PostScript, .jpeg and PDF formats.

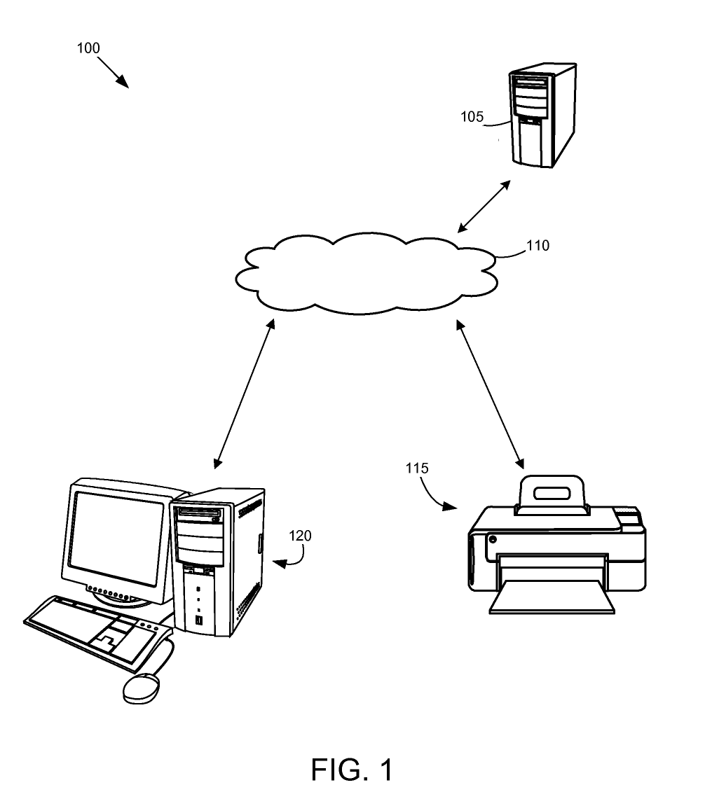

Referring to FIG. 1, there is shown a diagram of a system 100 according to one example embodiment. The system 100 may be a data communication system comprising a network 110 that interconnects a client device 120, an imaging device 115 and a print server 105. Imaging device 115 may be web-enabled and may be capable of communicating with print server 105. For example, imaging device 115 may be connected to print server 105 via a communication link, which may be established by a wired or wireless connection such as, for example, an Ethernet connection.

Client device 120 may be, for example, a personal computer system including a display, an input device (e.g., keyboard), a processor, input/output (I/O) interfaces, memory such as RAM, ROM, NVRAM and a mass data storage device such as a hard drive, CD-ROM and/or DVD units. During operation, client device 120 may include in its memory a software program including program instructions that function as an imaging or printer driver for imaging device 115. Imaging driver may communicate with print server 105 via a communications link. Imaging driver may facilitate communications between imaging device 115 and client device 120. In addition, imaging driver may provide formatted print data ready for printing by imaging device 115.

In another example embodiment, client device 120 may be a mobile device. The mobile device may be communicatively coupled to print server 105 in network 110 via a communications link. The mobile device may be any computing device that is portable, handheld or pocket-sized such as, for example, a mobile telephone (e.g., a cell phone), a smart phone, a handheld computer, a personal digital assistant (PDA), a notebook computer, a tablet computer, or any other remote computing device, such as a special-purpose remote computing device (e.g., an e-book reader). Additionally, the mobile device may include at least one control unit such as, for example, a processor that controls the operation of the mobile device.

A communications link, such as a cell phone data link, a WiFi link, or any other form of wired or wireless communication link, may allow client device 120 to communicate with print server 105 via network 110. Print server 105 may receive one or more files from client device 120 via the communications link. Client device 120 may upload or send the one or more files to print server 105 for rendering into a printable format for printing and/or for storing in print server 105 or in a storage location remote from either or both client device 120 and print server 105. Print server 105 may have an appropriate software application program that is capable of directing the translation of the one or more files to a format recognized by imaging device 115. Once the files or data has been translated into an appropriate format for printing, it may be referred to as a print job. Print server 105 may transfer the one or more files to a remote storage location, such as, for example, a database server, where the one or more files may be obtained by imaging device 115 for printing. It will be appreciated by one of ordinary skill in the art that in some example embodiments, client device 120 may render the one or more files into a printable format before uploading the one or more files to print server 105.

Print server 105 may be capable of buffering multiple print jobs sent by client device 120. Print server 105 may hold print jobs that are ready for printing by imaging device 115 in a print queue until imaging device 115 is ready to receive the print jobs or, alternatively, until imaging device 115 retrieves the print jobs from print server 105.

Print server 105 may be a stand-alone or single server or a part of a group of geographically dispersed servers that may be registered to a domain. The domain may be used to access the group of servers, among which is print server 105 that may be used to release print jobs to be printed by imaging device 115. The servers may be federated such that the servers may have a common set of protocols in place. The servers may be aware of each other and may communicate with each other. The servers may also transfer print jobs to one another when required. Further, the servers may be registered to the domain as print servers such that when client device 120 queries the domain to discover devices to perform a process such as, for example, to release print jobs, the servers are advertised as being available as print servers.

Imaging device 115 may be any device capable of printing or producing a hard copy data file or document stored in electronic form, such as a laser, inkjet or dot matrix printer or a multi-function printing device that has the capability of performing other functions, such a faxing, e-mailing, scanning and/or copying, in addition to printing. In one aspect of the first example embodiment, imaging device 115 may be configured to include the domain as a wide area domain to search using zero configuration networking.

In one aspect, imaging device 115 may include a processor (not shown) in communication with a user interface (not shown), a memory (not shown), and a scanning subsystem (not shown). The user interface may be a graphical user interface, a monitor, a series of buttons, a touch-sensitive display panel, a text interface such as a 2-line display, a voice-activated interface or the like. In one aspect, the user interface may serve as an operating panel for imaging device 115. Those skilled in the art will appreciate that imaging device 115 may include various additional components, such as a facsimile, scanner and/or card reader. Imaging device 115 may also include one or more appropriate software applications configured to receive print data or one or more files from print server 105 and to output printed pages through a print engine (not shown) of imaging device 115.

Imaging device 115 may include a communications interface and a control unit. The communications interface of imaging device 115 may allow imaging device 115 to function as a cloud printing release station and connect to network 110 to search for print server 105 among a group of servers and use print server 105 as a print release server. Additionally, imaging device 115 may be pre-set with a domain to use for searching for print server 105 using wide area zero configuration.

Imaging device 115 may also be configured with a cloud printing application that to is able to perform a zero configuration search of the domain. The zero configuration search of the domain may be implemented by searching print for server 105 for use as a print release server among a group of servers that may be connected in a wide area network. It will be understood that the cloud printing application may be a software application that is stored in memory associated with the control unit and executed by the control unit in accordance with programmed logic associated with the software application. In some alternative embodiments, the cloud printing application may be implemented in the firmware of imaging device 115.

Network 110 may be any Internet Protocol (IP) based computer network capable of communicating data and other information between client device 120, imaging device 115 and print server 105. Network 110 may comprise a Local Area Network (LAN) or a wide area network (WAN) (e.g., Internet), and may be a public or private network. Network 110 may use any communication medium, such as cable, optical fiber, radio carriers, etc., or any combination thereof, to communicate with client device 120, imaging device 115 and print server 105.

Imaging device 115 may be capable of retrieving print jobs from print server 105 via network 110 through a cloud printing solution. The cloud printing solution may be a cross-platform solution that enables a user of client device 120 to send one or more files for printing to print server 105 via network 110. Print server 105 may store the one or more files at or send the one or more files for storing to a location remote from print server 105, client device 120 and imaging device 115. In an alternative example embodiment, the one or more files sent from client device 120 to print server 105 may be accompanied by user credentials, such as identification information, that may correspond to the user initiating the printing and sending of the one or more files to print server 105. The user identification information may be attached to the one or more files in order to distinguish the one or more files as having been sent to print server 105 from client device 120 by a user registered to the cloud printing solution. The user identification information may be generated upon the user's registration to the cloud printing solution. With the cloud printing solution, imaging device 115 may retrieve the one or files from print server 105 using a cloud printing application installed in imaging device 115.

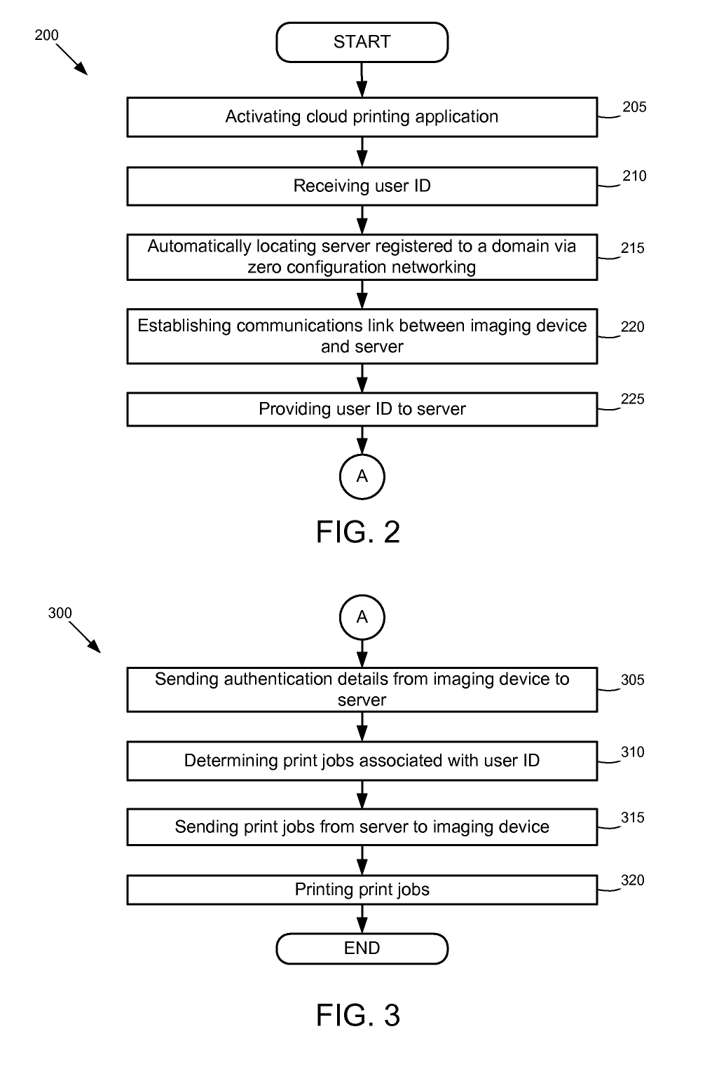

FIG. 2 shows one example method of locating print server 105 in a cloud printing to application to be used as a print release station. At block 205, the cloud printing application is activated in imaging device 115. The cloud printing application may monitor imaging device 115 for a user input or action, such as a button pressed or screen touched, and when detected, may initiate a workflow to control or direct imaging device 115 to retrieve and print a print job using the cloud printing application.

At block 210, imaging device 115 may receive user credentials or identification details from the user at imaging device 115. Imaging device 115 may present a dialog screen to the user for entering user identification information such as, for example, a username and password associated with the account of the user of the cloud printing application. In one alternative example embodiment, the user may present an identification card or badge to a card reader that may be installed in or attached to imaging device 115, and imaging device 115 may receive the user identification details directly from the card reader.

At block 215, imaging device 115 may automatically locate a print server registered to the domain of the cloud printing application via zero configuration networking. In one example embodiment, imaging device 115 may perform a zero configuration search of the domain and find servers registered to the domain. Zero configuration networking may be used by imaging device 115 to discover print release servers without a central server and without the need for network configuration by the user. The search may be performed in a wide area network such as, for example, the Internet. Print server 105 may release the print jobs associated with the user credentials or identification information received from the user of imaging device 115 at block 210.

If the group of servers registered to the domain is correctly federated, the cloud printing application may discover each of the servers from the group of servers registered with the domain and present the discovered servers to a user interface of imaging device 115 for selection by user. The cloud printing application may automatically determine without user intervention the most appropriate print server 105 among the discovered servers for the cloud printing application to communicate with. For example, the cloud printing application may perform an automatic geo-location process that determines and uses the geographic location of imaging device 115 to determine the IP address of imaging device 115 and select print server 105 in closest proximity to imaging device 115 from the discovered servers to to use in releasing the print jobs. The servers registered to the domain may be configured to control communication with imaging device 115 in a manner that results in the most efficient data path for communicating the print job from print server 105 to imaging device 115.

At block 220, a communications link is established between imaging device 115 and print server 105 via network 110. The cloud printing application may use this communications link to send user identification information to and receive information, such as a list of print jobs in the queue, from print server 105 (block 225).

FIG. 3 shows one example method of communicating with print server 105 to release print jobs to imaging device 115 for printing. At block 305, imaging device 115 may send user authentication information, such as user credentials or identification information, to print server 105. User identification information may be, for example, a username and password of the user of imaging device 115 that are associated with an account registered in the cloud printing application.

At block 310, print server 105 may determine which print jobs are associated with the user authentication information received from imaging device 115. The print jobs may be the one or more files sent to print server 105 via network 110 for printing by the user registered to the cloud printing application. The one or more files sent to print server 105 for printing may be stored in print server 105 or in a storage location remote to print server 105 and/or client device 120 along with the user credentials, indicating that the one or more files are associated with the user initiating printing with the cloud printing solution.

At block 315, the print jobs determined to be associated with the user may be sent from print server 105 to imaging device 115. When imaging device receives the print jobs from print server 105, imaging device 115 may then print the print jobs received from print server 105 (at block 320).

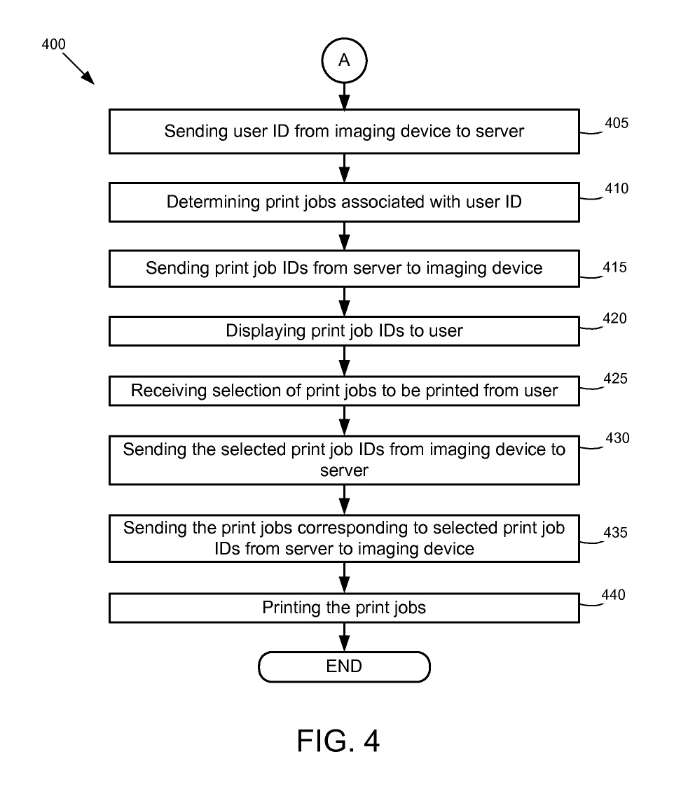

FIG. 4 shows one alternative example method of communicating with a print server to release print jobs to imaging device 115 for printing. At block 405, imaging device 115 may send user authentication information to print server 105. At block 410, print server 105 may which determine print are jobs associated with the user authentication information and send print job IDs of such print jobs from print server 105 to imaging device 115 (block 415). Print job IDs may refer to the unique identifiers of the print jobs or the unique identifiers of the one or more files sent by the user registered to the cloud printing application to print server 105 for printing by imaging device 115.

At block 420, print job IDs may be displayed in a user interface of imaging device 115 for selection by the user. In some alternative example embodiments, the filenames corresponding to the one or more files sent to print server 105 for printing may be displayed instead of or in lieu of the print job IDs. In yet other alternative example embodiments, the print job IDs may be a randomly generated filename corresponding to the file sent to print server 105 for printing. It will be understood that other information, such as a date stamp or time stamp, corresponding to the files associated with the user's account in the cloud printing application may be displayed in some example embodiments. At block 425, imaging device 115 may receive a selection of one or more print job IDs from the user. The selection may correspond to the print jobs that the user wishes to print, and imaging device 115 may send the selected print job IDs to print server 105(block 430).

At block 435, print server 105 may, retrieve the print jobs corresponding to the selected print job IDs and send the print jobs to imaging device 115. Imaging device 115 then receives the print jobs from print server 105 and prints the print jobs (block 440).

It will be appreciated that the actions described and shown in the example flowcharts may be carried out or performed in any suitable order. It will also be appreciated that not all of the actions described in FIGS. 2, 3 and 4 need to be performed in accordance with the example embodiments and/or additional actions may be performed in accordance with other example embodiments of the disclosure.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of printing, comprising:
initiating, at an imaging device, a search for a server registered to a domain using zero configuration networking;
receiving, from the server, a print job associated with a user account; and
printing the print job.

2. The method of claim 1, wherein the zero configuration networking is implemented in a wide area network.

3. The method of claim 1, further comprising determining a geographic location of the imaging device.

4. The method of claim 3, wherein the searching for the server searches for a server nearest to the geographic location of the imaging device.

5. The method of claim 1, further comprising receiving user authentication details associated with the user account from a user.

6. The method of claim 1, further comprising transmitting user authentication details received from a user to the server.

7. The method of claim 1, further comprising receiving the domain to be searched from a user.

8. The method of claim 1, wherein the domain is pre-set in the imaging device.

9. The method of claim 1, wherein the server is a cloud print server.

10. The method of claim 1, wherein the imaging device is a cloud printing release station.

11. A method of implementing a cloud printing solution, comprising:
connecting to a network;
automatically searching a print server registered to a domain using zero configuration networking; and
establishing a communications link with the print server,
wherein the connecting, the automatically searching and the establishing are performed by an imaging device.

12. The method of claim 11, further comprising receiving, from the print server, a print job associated with a user account.

13. The method of claim 11, wherein a user account is registered to the cloud printing solution.

14. The method of claim 11, wherein the establishing the communications link includes sending user account details from the imaging device to the print server.

15. The method of claim 11, wherein the print server authenticates the user account details.

16. An imaging device with a non-transitory computer-readable storage medium containing computer executable instructions to:
search a server registered to a domain using zero configuration networking;
receive, from the server, a print job associated with a user account; and
print the print job.

17. The imaging device of claim 16, further comprising the computer executable instructions to activate a cloud printing solution.

18. The imaging device of claim 16, wherein the user account is registered to a cloud printing solution.

19. The imaging device of claim 16, wherein the zero configuration networking is implemented in a wide area network.

20. The imaging device of claim 16, further comprising, the computer executable instructions to query the server for the print job associated with the user account.
